(19) United States
(12) Patent Application Publication
(10) Pub. No.: US 2005/0237949 A1
(43) Pub. Date: Oct. 27, 2005

(54) Dynamic connection structure for file transfer

(76) Inventor: Vincent M. Addessi, Pittsburgh, PA (US)

Correspondence Address: Gary L. Shaffer, Esq., 901 Banks Place, Alexandria, VA, 22312, US

(21) Appl. No.: 09/742,661

(22) Filed: Dec. 21, 2000

(51) Int. Cl. H04L 12/28

(52) U.S. Cl. 370/255; 709/203

(57) ABSTRACT

A means for and a method of transferring a data file to multiple computers on a network is disclosed. The file is transferred by a root client in packets to a number of other clients. Each of these clients sends the received packets on to a number of other clients as the packets are received. An ordered binary tree (heap) algorithm is used to determine positioning of clients in the dynamic connection structure. Additions and removals of clients can be achieved at any time by contacting affected clients, and modifying their connections to reflect the changes determined by the algorithm.

### BACKGROUND OF THE INVENTION

1. Field of the Invention

The present invention relates to computers systems and in particular to file transfers over computer networks.

2. Description of Related Art

It is common for many computers distributed across a network to each require a copy of the same file. For example, many people connected to the internet may all need a copy of an available program, document, or music file. A file server can only send a file to a limited number of clients simultaneously, and the speed of the file transfer decreases as new clients are added. Because of these limitations, multiple servers are frequently necessary in order to efficiently send a file to a large number of clients.

The most widely used method of transmitting files across a network is File Transfer Protocol (FTP). FTP allows a server to transmit a file to a client by breaking the file into packets and sending each packet independently. For an FTP server to send a file to multiple clients, the server is required to separately send the same packet to each client, which requires repetitious work and time delays.

Recent art makes use of peer-to-peer technology, in which a client receives a file and then sends it on to other clients. Use of this technology decreases the load on the original file server by utilizing the processing and transmitting capabilities of the clients. Unfortunately, current embodiments of this technology require the entire file to be transmitted to a client before that file can be retransmitted to other clients, producing undesirable delays.

File sharing programs such as Napster and Gnutella use peer-to-peer technology to transmit files between clients. In these systems, clients search for available files located on other client computers. A client is allowed to transfer a desired file via FTP from another client. These systems do not make provisions to transfer one file efficiently to a large number of clients, they merely give a client a wide selection of other clients to receive a file from, increasing the probability that an available source is found.

Several recent attempts to increase the efficiency of file transfer over networks have concentrated on determining one or more efficient routes between clients. Some such attempts have used algorithms including spanning tree algorithms to determine the optimal route over a set of potentially active connections. See U.S. Pat. No. 4,905,233, U.S. Pat. No. 6,098,107, and U.S. Pat. No. 6,044,075. However, such art has not provided a means of creating and removing connections between clients as data packet transmissions take place over said connections. Nor has such art yielded a method by which clients in a peer-to-peer communication network are able to retransmit a file before said file is first received in full.

The method of transferring files by cascaded release describes an application of peer-to-peer technology that allows a file to be transmitted from a server to a number of clients. See U.S. Pat. No. 5,995,982. This method allows a group of clients to receive a file from the server and then send the file on to other clients. This method arranges a list of clients into groups, and does not allow a client in a group to begin transmission until a client in the previous group has fully received the file. The organization of connections between clients in the list remains static once the list is created. This method does not make provisions for dynamically redefining the distribution list by adding, removing, and repositioning clients while files are being transmitted between clients in the list. In addition, for a client to retransmit a file after receiving it, the client computer is required to remain connected to the network after it has received the file, which is not always desirable. No existing technology allows clients to retransmit packets of a file to other clients as packets of the file are being received.

There is a need in the art to mitigate the time bottleneck associated with the transfer of a file to a number of other computers and the limitations in the number of simultaneous file transfers. An invention should provide clients in a network with the means to dynamically change their connections with other clients at any time. Such an invention should also provide a client in a network with the ability to retransmit packets to other clients as packets are being received. Ideally, such an invention should ensure that no client receives packets from another client with a slower network connection speed.

### BRIEF SUMMARY OF THE INVENTION

The invention provides a method for transferring a file from one computer to many computers distributed across a network. A program called a server is executed on a computer connected to the network. A program called the root client is executed on a computer connected to the network which has direct access to the file which is to be transferred. A program called the client is executed on each computer which requires receipt of the specified file.

A dynamic connection structure of clients is established comprising all clients involved in the file transfer and their connections to each other. This dynamic connection structure is generated using an incomplete binary heap algorithm (defined below) as follows. For each client added to the dynamic connection structure, a node is added to the heap. For each client removed from the dynamic connection structure, the node corresponding to that client is removed from the heap. There is always a direct mapping between nodes in the heap and clients in the dynamic connection structure.

Nodes in a binary heap can have a parent and up to two children. Henceforth, any reference to a given client's parent implies the client which corresponds to the parent node of the node which corresponds to the given client. In other words, if Node A in the heap corresponds to Client A, and Node B corresponds to Client B, and Node A is the parent of Node B, then Client A may be referred to as the parent of Client B. The same is true of references to a given client's children.

The server program is responsible for creating and maintaining the heap. When a new client requires addition to the dynamic connection structure, the client contacts the server and requests addition. The server then adds a node representing the client to the heap using the incomplete binary heap addition algorithm, and sends the client an encoded representation of its corresponding resultant subheap. The client then inserts itself into the dynamic connection structure by contacting necessary clients, providing them with connection information derived from the server's message, and cooperatively establishing the specified connections. When a client has received the entire file or when a client crashes (hangs), a removal from the dynamic connection structure is accomplished similarly. The parent of the client contacts the server, the server removes the corresponding node from the heap, and sends information which includes a description of the new subheap to the parent. The parent then makes the necessary communications to enable the dynamic connection structure to reorganize itself in a way which contains no connections to the removed node. Thus, the server program facilitates the file transfer by organizing and specifying appropriate alterations to the connections over which the packets are transferred.

The root client is responsible for dividing the file into packets, and these packets are passed sequentially over the open connections in the dynamic connection structure. Packets are always passed from a parent client to a child client. The root client passes a packet to its child clients. Each of these clients passes the packet to their child clients, and the process continues until every client has received the packet. Packets are transferred between two connected clients without intervention. In other words, if two clients have an open connection, they will always repeatedly transfer packets until disconnected. The present invention represents a dramatic improvement on current file transfer technologies because it allows client programs to send packets to their children while receiving packets from their parents. As soon as a client has received a packet, it is able to receive the next packet. Essentially, every client in the dynamic connection structure can be receiving the file simultaneously.

### BRIEF DESCRIPTION OF THE DRAWINGS

Not Applicable

### DETAILED DESCRIPTION OF THE INVENTION

Preface

In the following detailed description, a specific embodiment of the invention is shown by way of illustration. This embodiment is described in sufficient detail to enable those skilled in the art to make and to use the invention, and it is to be understood that many other embodiments may be specified that fall within the scope of the present invention. The following detailed description should not be construed to limit the scope of the invention as defined by the appended claims.

This embodiment uses two Java programs, a j-server and a j-client program. Any reference to a j-server implies an executing instance of the j-server program. Any reference to a j-client implies an executing instance of the j-client program. Any reference to a root j-client implies an executing instance of the j-client program configured to be a root. Any reference to a general j-client implies an executing instance of the j-client program not configured to be a root.

Incomplete Binary Heap Algorithm

To model the dynamic connection structure, this embodiment employs a modified binary heap data structure as the most appropriate type of binary tree. The dynamic connection structure is considered dynamic because additions and deletions are permitted any time after the heap is initialized and before the heap is destroyed. The embodied heap sorting requirement is that any j-client in the dynamic connection structure must always have a slower network connection speed than its parent. Each j-client's network connection speed is determined prior to the insertion of a node corresponding to that client in the heap, and is used as the sort key for the heap.

In this embodiment, the heap properties are modified as follows:
1. the heap is no longer required to satisfy the completeness property;
2. the repositioning of nodes in the heap following an addition or deletion of a node, should never cause a node corresponding to a j-client to be repositioned more than one step away from its previous position.

The completeness property of a binary tree requires that every level except the last is full, and that on the last level, all internal nodes are to the left of external nodes. In a standard binary heap, the completeness property must always be satisfied. Following the addition or removal of nodes, reorganization of the heap is often required to maintain the completeness property.

The removal of the completeness requirement is desired in this implementation, because we prefer reorganization of the heap to be kept to a minimum. In the dynamic connection structure, the work done processing modified connections and contacting other j-clients can cause time delays, and these delays should be minimized. By eliminating this requirement, the heap removal algorithm is simplified to require only a down-heap following a delete. It is no longer necessary to swap the positions of two nodes prior to a delete. This is desirable, because swapping nodes on different levels of the heap may result in situations where a j-client has a set of packets that the j-client's parent does not have yet. For example, consider a j-client at level 2 of the heap which has received packets 0 through 10, and a j-client at level 6 of the heap that has received packets 0 through 5. Swapping the positions of these j-clients in the heap could require the j-client now at level 2 to request packets 6 through 10. This would obviously create unnecessary packet transfers.

By introducing these modifications to the heap requirements, we are able to simplify the heap addition and removal algorithms to the following:

```
heap addition (insertion)
Algorithm insert(w)
{
  p = the first open position in the heap
  heap(p) = w
  call upHeap (p)
}
heap removal (deletion)
Algorithm delete(w)
{
  p = the position in the heap of node w
  call downHeap (p)
}
```

The first open position in the heap is specified in the insert algorithm as the leftmost position not occupied by a node in the highest level in the tree which is not full. The upHeap and downheap algorithms remain the same as in a standard binary heap algorithm.

These simplifications ensure that the addition or removal from the heap of a node corresponding to a single j-client will never cause a node corresponding to another j-client to be moved further than one step along a path in the tree. Thus, these simplified algorithms satisfy the second requirement that a node corresponding to a j-client is never repositioned more than one step away from its previous position in the heap.

The modified binary heap is used to model the dynamic connection structure of j-clients by using a node in the heap to represent a j-client in the dynamic connection structure. Each node in the heap can have a parent and up to two children. In the dynamic connection structure, each j-client can have a parent and up to two children. The parent of a j-client is a j-client which is responsible for sending data packets to that j-client. The children of a j-client are j-clients to which that j-client will send data packets. Thus, the representation of the heap at a given time can be used to determine which network connections for a given j-client should be actively sending and receiving data packets at that time.

For the purposes of this specification, the term incomplete binary heap or incomplete binary heap structure or incomplete binary heap data structure will be defined as a data structure possessing the characteristics of a binary heap modified in the manner described above. The term incomplete binary heap algorithm will be defined as an algorithm possessing the characteristics of a binary heap algorithm modified in the manner described above. The terms incomplete binary heap addition algorithm and incomplete binary heap deletion algorithm will be defined as the addition (insertion) algorithm and the removal (deletion) algorithms described above.

While it may be possible to further refine these algorithms or to use or modify other tree organization algorithms to enhance the performance of the invention, the use of any binary tree or m-ary tree structure to model the dynamic connection structure described herein would not fall outside of the scope and spirit of the present invention.

Socket Transmission of Packets

For the purposes of this specification, a data packet or packet shall be defined as an individual segment of information resulting from the division of a larger set of information into one or more parts.

For the purposes of this embodiment, a data packet or packet shall be defined as an individual segment of data bytes resulting from the division of a file.

For the purposes of this specification, any references to transferring a file at the packet level shall imply dividing the file into packets, and transferring the packets individually.

Socket implementations in a programming language are common in the art. A socket is used in a computer program to connect to, receive connections from, send information to, and receive information from other computers. All communications between computers on a network in this embodiment are accomplished using sockets. Other utilities used to transmit data packets from one computer to another, would not fall outside of the scope and spirit of the present invention.

In this specification, any reference to connections or active connections indicates the set of open network connections between a j-client or j-server and another j-client or j-server. Any connection described in this embodiment indicates open TCP socket connection between two programs, which implies open TCP connection between the computers on which the programs are running. If the two programs are running on the same computer, this still holds true.

In this specification, any reference to a program opening a connection, opening a network connection, or connecting to another program implies the following steps:
1. The computer on which the program is running uses a socket to contact a computer on a specified port, and requests that a connection be established.
2. The contacted computer accepts, rejects, or does not respond to the request.
3. If the contacted computer accepts the connection within a certain amount of time, the connection is considered open and the sockets are considered connected.
4. If the computer to which contact is attempted rejects or does not respond to the request within a given amount of time, the connection is considered closed, and the sockets remain unconnected.

Any references to sending or transmitting data, a message, or a packet from a source program to a destination program implies the following:
1. A network connection is open between the sender and receiver.
2. The source program transforms the message into data bytes as specified by a protocol.
3. The source program transmits the message over the open connection.
   Definitions of Entities Involved

A dynamic connection structure of clients or a dynamic connection structure is defined for the purposes of the specification of the present invention as a set of clients and a set of open network connections between these clients, of which the following are true:
information is capable of being transmitted across included network connections at any time;
the set of network connections may be modified at any time.

All programs described herein imply computer programs or processes executing on a computer connected to a network. The specific computers may vary in any way, but they must all be connected to the same network. This network will henceforth be referred to as Network A.

A data file may be transmitted from a source computer to a number of other computers over a network using dynamic connection structure means. The methods described pertain to transfer of a specific file, which may or may not be identified prior to initiation of these mechanisms. In this embodiment, the file to be transferred will be predetermined, and this file will henceforth be referred to as File A.

For the purposes of this specification, the definition of binary heap is consistent with the commonly understood definition in the art.

For the purposes of this specific embodiment of the invention, the term binary heap or heap designates an incomplete binary heap structure containing one node for each j-client in the dynamic connection structure. The heap provides a model of the dynamic connection structure and is used to determine connection information.

If Node A in the heap, which has children Node B and Node C, corresponds to j-client A in the dynamic connection structure, and Node B and Node C in the heap correspond to j-client B and j-client C in the dynamic connection structure, respectively, it is implied that j-client A is responsible for sending data packets to j-client B and j-client C. Information stored in the heap for each j-client is:
Unique j-client ID used to identify each j-client in the dynamic connection structure.
j-client IP address.
j-client network port base (defined below).
j-client connection speed to Network A.

For the purposes of this specification, a client is defined as a computer program capable of connecting to, receiving connections from, sending information, and receiving information from other computer programs. An external client is a client that is not included in a specified dynamic connection structure.

For the purposes of this specific embodiment of the invention, the definition of a j-client shall be customized to refer to a program executing on a computer connected to Network A that is responsible for receiving packets from a source and sending those packets on to its children, and is also responsible for listening for connection change information, and making the specified connection changes when they are received.

The root j-client is a specific type of j-client. This program must be executing on a computer that has direct access to File A. It is preferred that the root j-client is executed on a computer that holds File A on its local disk. Because it is the reference source of File A, the node corresponding to the root j-client is always positioned at the top of the tree that models the dynamic connection structure. The root j-client is responsible for extracting packets from the local copy of File A, and sending them to its children. In this embodiment, only one root j-client will be used. However, additional root j-clients could be added; for instance, to provide failover protection. A root j-client is always assigned a connection speed of 0, which the binary heap sort key recognizes as the fastest defined network connection speed. This ensures that the no general j-client will ever be repositioned such that the root j-client is its child.

A general j-client refers to any j-client that is not a root j-client.

For the purposes of this specification, a server is defined as a computer program which is capable of connecting to, receiving connections from, sending information to, and receiving information from other computer programs, and that performs administrative tasks necessary to the overall implementation. The distinction between a client and a server should not be construed to mean that clients are incapable of performing administrative tasks, the distinction is drawn simply for the purpose of clarifying the specification. An external server is a server that is not included in a specified dynamic connection structure.

For the purposes of this specific embodiment of the invention, the definition of a j-server or file j-server shall be customized to refer to a program executing on a computer connected to Network A, which may or may not be executing on the same computer as the root j-client, and which is responsible for the following:
Maintaining the dynamic connection structure, using incomplete binary heap addition and removal algorithms.
Servicing requests from j-clients to be inserted into the dynamic connection structure, by adding a node corresponding to the j-client to the heap, and responding to the j-client with new connection information as determined by the resultant heap structure.
Servicing requests from j-clients to remove j-clients from the dynamic connection structure, by removing a node corresponding to the specified j-client from the heap, and responding to the j-client with new connection information as determined by the resultant heap structure.

A j-server program maintains one socket and one network port. A j-server must listen for connections from j-clients, and process the messages received. The j-server listens for these connections on a network port on the computer it runs on. This port is referred to as the j-server port. The socket which facilitates communication on the j-server port is referred to as the j-server socket.

A general j-client maintains four sockets and four network ports. The first port is used to listen for connections, and to receive messages regarding connection changes. This port is referred to as the info port. The second is used to connect to a parent j-client, and to receive packets from the parent j-client. This port is referred to as the parent port. The next two are used to receive connections from up to two child j-clients, and to send packets to these child j-clients. These ports are referred to as child ports. The sockets that facilitate communication on the info, parent and child ports are referred to as the info socket, the parent socket, and the child sockets respectively.

By convention, the four ports used by a j-client will be sequentially assigned starting with a base port number. The info port is assigned the base port, the parent port is assigned the base port +1, the child ports are assigned the base port +2 and base port +3. A j-client program is responsible for finding 4 adjacent open ports prior to its initial contact to the server.

For the purposes of this specification, connection information or connection information for a client is defined as information which indicates to a client the appropriate connections which the client should establish with other clients and connection information for other clients.

Packet Numbers

The root j-client, which acts as the source of File A, is responsible for partitioning the file into one or more manageable chunks, referred to as data packets. The packet size is arbitrary, but should be chosen to be relatively small, so that no message takes excessively long to be decoded by j-clients. Each packet is assigned a packet number (packet num).

When a new j-client is inserted in the dynamic connection structure, it does not request any packets from its parent until it receives packet requests from all of its children. It then requests the earliest packet required to be transferred to its children. If a j-client is inserted to a position where it has no children, it requests ANY_PACKET from its parent. If the parent has no other child, it will begin transmitting with the earliest packet it possesses. If the parent has another child, it will begin by transmitting the packet that it is currently transmitting to the other child. This technique insures that child j-clients do not have to wait for an inserted parent to receive packets that they already have. When a j-client is inserted, its children will have to wait a minimal amount of time before they can continue receiving their packets.

The root j-client will begin packet transmissions to its first child with packet number 0. If File A contains n packets, the packets are numbered 0 to n-1. The root j-client will send each packet sequentially as they are requested until packet n-1 is sent. The root j-client will then return to packet 0 and repeat the whole process.

A j-client in the dynamic connection structure always receives packets in sequential order, but not necessarily starting with packet 0. After packet n-1 is received by a j-client, the j-client will wrap back around to packet 0, and begin receiving packets. If a j-client starts receiving packets with packet m, it will receive sequentially packets m through n-1, then 0 through m-1. The j-client will then transmit a final packet to its children, close connections with its children, and be removed from the dynamic connection structure.

This technique insures that a j-client in the dynamic connection structure will never need to request a packet that each of its children already has. In addition, a j-client is able to leave the dynamic connection structure (and disconnect from Network A) almost immediately following receipt of the last packet.

Protocol

The protocol implemented in this embodiment provides a means of communication between j-client and j-server programs. A message transmitted from one program to another in this system is structured as follows:
Message ID
Message type
Message parameter list
Included data packet size (if necessary)
Included data packet as an array of bytes (if necessary)

Each of the above message sections are separated by an end-of-line character. The last two are only necessary if a data packet is contained in the message. In the embodied protocol, there are only two message types that require a data packet be included. The message ID is a numeric id that is incremented each time a message is sent on a specific connection. This ID is used to insure that messages are not processed more than once, and to ensure that messages do not arrive out of sequence.

In certain situations, a message is used to inform a j-client that its active connections should be changed. Because insertions and deletions may require multiple j-clients to change their connections, and these affected j-clients always end up in a chain, we choose, in this implementation, to notify only a single j-client of the changes, and pass these changes down through the dynamic connection structure. This takes the load off of the j-server, by making it unnecessary for the j-server to contact many j-clients to handle a single insert or delete. To generate connection information relating to a j-client, an inorder traversal of the subheap is performed, starting at the node representing the specified j-client. The j-client ID of each j-client in the subheap is appended to a delimited string. This string, henceforth called an encoded tree, can be used by any included j-client to determine the manner in which their connections should be changed.

Given two j-clients j-client A and j-client B, the following convention is used. When j-client A sends an encoded tree to j-client B, the encoded tree is the encoded version of the subheap starting at j-client B. When a j-client needs to send new connection information to a new child, that j-client will generate an encoded tree for its child, which is the encoded version of the subheap starting at that child.

The following is a list of the valid message types, and their parameters:

| | |
|---|---|
| REQUEST_INSERT | j-clientId |
| REQUEST_INSERT_ROOT | j-clientId, filename, |
| | fileLength |
| INSERT_INFO | encoded tree, filename, |
| | fileLength |
| NEW_PARENT_TREE | encoded tree, parentPort |
| SET_CHILDREN | encodedTree |
| REQUEST_PACKET | packetNum |
| CHILD_INFO_RECIEVED | packetNum, packetSize, |
| | byteArray |
| YOU_ARE_THE_ROOT | no params |
| ALREADY_HAVE_ROOT | no params |
| WAITING_FOR_ROOT | no params |
| PACKET_HERE | packetNum, packetSize, |
| | byteArray |
| PACKET_HERE_BYE | packetNum, packetSize, |
| | byteArray |
| INVALID_PACKET_REQUEST | packetNum |
| INVALID_PACKET_REQUEST_BYE | no params |
| DELETE_CHILD | clientId |
| DELETE_INFO | encoded tree |
| OK_BYE | no params |

The REQUEST_INSERT and REQUEST_INSERT_ROOT message types allow a general j-client or a root j-client to request insertion into the dynamic connection structure. The unique j-client ID is included in each, and it includes the j-client's connection speed and network port base.

The messages YOU_ARE_THE_ROOT allows a j-server to notify a root j-client that it has been added to the root of the heap.

The message ALREADY_HAVE_ROOT allows a j-server to notify a root j-client that it was not added to the tree, because a root j-client already exists.

The INSERT_INFO message is sent from a j-server to a newly added j-client. This message includes the encoded tree of the j-client's new parent, and information about the file being served.

The NEW_PARENT_TREE message is used to inform a j-client that it must change its child and parent connections. The encoded tree contains the j-client's new connection information, and new connection information for all j-clients included in the given j-client's representative subheap. The parent port specifies the network port on which to contact the new parent.

The message SET_CHILDREN is identical to the NEW_PARENT_TREE message, except it implies that only the j-client's children are changing, and does not need to send a parent port.

The message REQUEST_PACKET allows a child to request a specific packet from its parent. PacketNum is the unique identifier of the packet needed.

The message CHILD_INFO_RECEIVED is used identically to the message REQUEST_PACKET, except it implies that newly sent connection information was received.

The message PACKET_HERE is used to send a packet from a parent j-client to a child j-client. It includes the packet number, the packet size, and the data packet as an array of bytes.

The message PACKET_HERE_BYE is identical to the message PACKET_HERE, except it implies that the connection is being closed after acknowledgement of its receipt.

The message INVALID_PACKET_REQUEST allows a parent j-client to notify a child j-client that it does not have the requested packet.

The message INVALID_PACKET_REQUEST_BYE is identical to the message INVALID_PACKET_REQUEST, except it implies that the connection is being closed after acknowledgement of its receipt.

The message DELETE_CHILD allows a j-client to notify a j-server that its child j-client requires deletion from the connection structure.

The message DELETE_INFO is sent from a j-server to a j-client which requested deletion of a j-client. This message includes a new encoded tree for the j-client.

The message OK_BYE is used to acknowledge receipt of a message, and to notify the recipient that the connection is being closed.

The following 4 sequences of communication are available:
1. A j-client contacts a j-server to request addition to the dynamic connection structure
   J-client uses info port, j-server uses j-server port
   J-client sends REQUEST_INSERT or REQUEST_INSERT_ROOT.
   J-server responds YOU_ARE_THE_ROOT, ALREADY_HAVE_ROOT, or INSERT_INFO.
2. A j-client contacts a j-server to request that one of its child j-clients be removed from the dynamic connection structure
   J-client uses info port, j-server uses j-server port
   J-client sends DELETE_CHILD.
   J-server responds DELETE_INFO.
3. J-client A transmits information about changing connections to J-client B
   J-client A uses info port or parent port, J-client B uses info port
   J-client A sends SET_CHILDREN, or NEW_PARENT_TREE.
   J-client B responds OK_BYE or CHILD_INFO_RECIEVED.
4. J-client A attempts data packets transmission to J-client B
   j-client A uses a child port, J-client B uses parent port
   J-client B sends REQUEST_PACKET.
   J-server responds PACKET_HERE, PACKET_HERE_BYE, INVALID_PACKET_REQUEST, or INVALID_PACKET_REQUEST BYE.

This protocol is obviously just one example of a protocol that could be used to transmit data packets and to facilitate changes to the dynamic connection structure described herein. Any other protocol used to facilitate similar changes to a dynamic connection structure would not fall outside the scope of the present invention.

Programming Solution

The j-server program does the following when executed:
1. Initialize the binary heap to empty.
2. Initialize the j-server socket and begin listening for connections on the j-server port.
3. Wait for a connection on the j-server port.
4. When a connection is received, wait for a message and process it.
5. Send an appropriate reply.
6. Close the connection and continue listening on the j-server port.
7. Go back to step 3 and repeat.

When any of the above steps refers to processing a message, it implies the following:
If the message is a request to be added to the heap, the j-server program adds a node corresponding to the j-client to the heap in its memory, generates an encoded tree for the j-client's highest level ancestor for which connections change, and sends an appropriate reply.
If the message is a request to remove a specified node from the heap, the j-server program removes the nod corresponding to the specified j-client from the heap in its memory, generates an encoded tree for the j-client, and sends an appropriate reply.

The j-client program does the following when executed:
1. Assess the network connection speed of the computer on which it is executing.
2. Generate a unique j-client ID, which includes IP address, connection speed, base port, and a timestamp.
3. Use the local info port to connect to the remote j-server port and request addition to the tree.
4. Receive connection information from the j-server.
5. Close the connection on the local info port.
6. Use the local parent port to connect the info port of the heap ancestor specified by the j-server.
7. Send the new connection information over this connection.
8. Close the connection.
9. Spawn threads.
10. Begin listening on the local info port, and child ports.
11. Check the info port for a connection, and if a connection has been requested, do the following:
   Accept the connection
   Receive new connection information over the info port.
   Close the connection on the info port and continue listening.
12. If new parent information has been received, do the following:
   Disconnect the parent port from the current parent.
   Connect the parent port to the new parent on the remote port specified.
13. If the parent port is connected, send the parent a request for the next needed packet.
14. Check the parent port for a message from the parent.
15. If a message has been received from the parent, process it.
16. If any children have changed, do the following for each changing child:
   Disconnect the child port from the current child.
   Connect the new child on their info port.
   Send the new child their new connection information, which can be derived from the last received encoded tree.
   Close the connection on the child port, and continue listening.
17. Check each child port that is not connected for a connection, and if a connection has been requested, accept the connection.
18. For each child port that has an open connection, check for a message.
19. Process each message that has been received from children.
20. Go back to step 10 and repeat until all packets in File A have been received.
21. Assemble all packets into a complete copy of File A.

When any of the above steps refers to processing a message, it implies the following:
If the message contains a data packet, the data packet is saved to disk.
If the message contains connection information, this connection information is saved to memory.
If the message contains a BYE, the connection is immediately closed.

Each of the steps from 10 to 18 are sequence independent. In other works, any step can be run at any time, and it will not disturb the integrity of the process. To make the info, parent, and child processes less dependent on each other, Java threads are used. Java threads allow a program to execute multiple processes simultaneously, so that delays in one process do not delay other processes. In this implementation, a j-client spawns 3 threads at step 9. The first thread handles all parent port communications, the second and third handle all communications over the first and second child ports, respectively. The original process continues to handle all communications over the info port. This is desired, because sending and receiving different messages over different ports will not interfere with each other.

This programming solution is obviously just one example of a solution that could be used to implement the file transfer method described herein. Any other programming solution used to facilitate similar changes to the described dynamic connection structure would not fall outside of the scope and spirit of the present invention.

Implementation

The j-server program is executed on a computer connected to Network A. A j-client program is executed on a computer connected to Network A and with local access to File A, and it is configured to run as the root j-client. This program contacts the j-server, and requests addition to the dynamic connection structure, as the root j-client. The j-server adds the root j-client to the heap, and replies, signifying that the addition was successful, and closes the connection.

Any number of j-client programs are then executed any number of times on computers connected to Network A. Each time a j-client program is executed, it contacts the j-server and requests addition to the dynamic connection structure. The j-server adds a node corresponding to the j-client to the heap, which results in the repositioning of a number of nodes along a path in the heap. The j-server replies, signifying that the addition was successful, and sends to the added j-client an encoded tree relating to the j-client at the highest level in the tree whose connections are affected by the addition (the ancestor). The j-client contacts this ancestor, sends the new connection information generated by the j-server, and closes the connection. The ancestor then modifies its own connection information, by closing appropriate connections and contacting new children. It sends its new children their new connection information, which is extracted from the encoded tree, and then closes the appropriate connections. This process repeats; each j-client whose connections are affected closes the appropriate connections, contacts its new parents if necessary, and sends new connection information to its children.

If a j-client receives a message from a child signifying that the child has received all packets in File A, or if a child or parent does not communicate for a certain amount of time (crashed or hung), the hung j-client is removed from the tree. To accomplish this, the j-client formerly connected to the hung j-client contacts the j-server and indicates to the j-server which j-client must be deleted. The j-server deletes the node corresponding to the j-client requiring deletion from the heap, which results in repositioning of a number of nodes along a path in the heap. The j-server replies, signifying that the deletion was successful, and sends to the j-client a new encoded tree. Similarly to j-client addition, new connections are established as the information is passed down the heap.

While all of this is happening, all j-clients that have open parent and child connections are sending and receiving data packets of File A.

Because changes to the heap in the j-server's memory do not immediately take effect (they are passed down the heap over time), the actual dynamic connection structure does not always exactly match the heap representation in the j-server's memory. In addition, because many additions and deletions may be performed by the j-server sequentially, and these changes are constantly filtering down the heap, the actual dynamic connection structure may never exactly match that of the heap. The heap is thus considered to always represent an ever-changing goal state that the dynamic connection structure is working towards. To ensure that additions and deletions of j-clients never conflict with each other, the j-server affixes a timestamp to every encoded tree it generates. When a j-client generates an encoded tree to be sent to a child j-client, the newly generated encoded tree is assigned the same timestamp as the encoded tree which was used to generate it. If a j-client ever receives connection information that includes a timestamp which is earlier than the timestamp on the last applied connection changes, the information is ignored.

Additional Notes

Other embodiments of the present invention are possible that fall within the scope of the present invention. In other embodiments of the invention, the tree representing the dynamic connection structure may be organized using a different algorithm. For example, an ordered binary tree may be implemented in such a way that j-clients located geographically near one another would be grouped together on branches of the tree. This may be shown to further minimize file transfer time. Another embodiment of the invention could include a checksum feature to ensure the accuracy of the file transfer, or include provisions for packet encryption or other security measures. In addition, the method could be modified to stream an audio or video file in such a way that each packet is played on the j-client computer as it is received.

Any such minor modifications to the present invention fall within the scope of the claims advanced herein. This application is intended to cover any adaptations or variations of the present invention. Therefore, it is manifestly intended that the scope of this invention be limited only by the attached claims.

1. Dynamic connection structure means for transmitting packets between clients on a network.

2. Binary tree algorithm means for determining client connections in a dynamic connection structure.

3. Ordered binary tree algorithm means for determining client connections in a dynamic connection structure, wherein the positioning in the binary tree of nodes, which correspond to clients in said dynamic connection structure, is ordered by one or more characteristics of said clients.

4. A means of transmitting messages between clients in a dynamic connection structure, or between clients in said connection structure and external servers, or between external clients and external servers in a way which facilitates both the repetitive transmission of packets between clients in said dynamic connection structure and the repetitive reorganization of said dynamic connection structure.

5. A method of transferring a file between clients over a network comprising the steps of:
creating of a dynamic connection structure of clients;
dividing the file into packets;
transferring each of the packets sequentially across open network connections contained in the dynamic connection structure.

6. A method of generating a dynamic connection structure of clients comprising the order independent-steps of:
adding a node to an ordered binary tree using a binary tree addition algorithm, where the node added corresponds to a client which requires addition to the dynamic connection structure;
establishing a client's appropriate network connections based on the corresponding node's position in the ordered binary tree;
removing a node from an ordered binary tree using a binary tree removal algorithm, where the node removed corresponds to a client which requires removal from the dynamic connection structure.

7. The method of claim 6, wherein the positioning of a client's corresponding node in said binary tree is determined by one or more characteristics of said client.

8. The method of claim 6, wherein the positioning of a client's corresponding node in said binary tree is determined by said client's network connection speed.

9. The method of claim 6, wherein the type of binary tree addition algorithm used is an incomplete binary heap addition algorithm and the type of binary tree removal algorithm used is an incomplete binary heap removal algorithm.

10. The method of claim 9, wherein the positioning of nodes in the tree is ordered by one or more characteristics of said nodes' corresponding clients.

11. The method of claim 9, the positioning of nodes in the tree is ordered by the relative network connection speed of said nodes' corresponding clients.

12. A method for performing reorganization of a dynamic connection structure comprising the steps of:
sending to clients information which includes new connection information;
modifying said clients' active connections in a manner determined by said information.

13. A method of repeatedly transmitting data packets between clients in a dynamic connection structure and repeatedly reorganizing said dynamic connection structure comprising the following order-independent steps:
a client contacts a server to request addition to the dynamic connection structure;
a server transmits information including new connection information to a client;
a client transmits information including new connection information to a client;
a client transmits information including new connection information to a server;
a client in said dynamic connection structure transmits one or more data packets to another client in said dynamic connection structure;
a client in said dynamic connection structure transmits information to a server regarding a client which requires removal from said dynamic connection structure.

14. A method of modifying a client in a dynamic connection structure's active connections comprising the following steps:
a client or server sends the client new connection information, which includes information referencing clients with which connections are required;
said client which receives said information completes transmissions over connections that are required to be closed, and then closes said connections;
said client establishes connections with clients, as specified in said new connection information.

15. A method of modifying the active connections of a client in a dynamic connection structure comprising the following steps:
a client or server sends the client new connection information, which includes information referencing clients with which connections are required, and also includes new connection information for any of said clients;
said client which receives said information completes transmissions over connections that are required to be closed, and closes said connections;
said client establishes connections with clients, as specified in said new connection information;
said client sends new connection information to any of said clients which require new connection information.
